(19) United States
(12) Patent Application Publication
(10) Pub. No.: US 2006/0097906 A1
(43) Pub. Date: May 11, 2006

(54) Radar-transceiver for microwave and millimetre applications

(76) Inventor: Patric Heide, Vaterstetten (DE)

Correspondence Address: FISH & RICHARDSON PC, P.O. BOX 1022, MINNEAPOLIS, MN, 55440-1022, US

(21) Appl. No.: 10/541,994

(22) PCT Filed: Dec. 16, 2003
(86) PCT No.: PCT/EP03/14347

§ 371 Date: Aug. 9, 2005

(30) Foreign Application Priority Data
Jan. 13, 2003 (DE) 103 00 955.8

(51) Int. Cl. G01S 13/00

(52) U.S. Cl. 342/22; 342/118

(57) ABSTRACT

This invention concerns a transceiver module (send/receive module) for microwaves and millimeter wave applications or associated module platform concepts for interconnecting partial modules to make an overall module, which is particularly suitable for mass production. The transceiver module contains a) one or more individual electronic components, which in particular comprise active circuit components of an (preferably voltage-controlled) oscillator, a mixer and a frequency divider, and b) a substrate with a multilayer structure and integrated circuit elements, in particular a hybrid ring of the mixer and a resonant circuit of the voltage-controlled oscillator. The individual electronic components are located on the top side of the substrate. This invention makes it possible to combine the send and receive functions in a compact component with a three-dimensional integration of the high frequency components.

This invention concerns a radar transceiver (transmit/receive module) for microwave and millimeter wave applications and associated module platform concepts for interconnecting sub-modules into a complete module.

A radar transceiver is a very high frequency device for locating objects in space or for measuring speed which can emit electromagnetic waves and can receive and process electromagnetic waves reflected by the target object. A radar transceiver usually contains several interconnected very high frequency modules which perform various functionalities in the frequency range of 1 to 100 GHz.

The frequency range between 1 GHz and 30 GHz is called the microwave range (MW range). The frequency range from 30 GHz upward is called the millimeter wave range (mmW range). The very high frequency modules differ from the high frequency modules in particular in that “wave guides”, e.g., micro strip circuits and coplanar circuits, are usually used for very high frequency circuits beyond 5 GHz.

Transceivers or transceiver components are particularly employed in the following areas of application: for automobile radar modules, for example automobile radar at 24 GHz and 77 GHz, for keyless entry systems, as well as generally for data communication systems, e.g., for Wireless Local Data Networks WLAN, optical modules, such as multiplexers, modulators and transmitter/receiver units, for front end modules for broadband communication, e.g., LMDS (Local Multimedia Distribution System) and base stations of radio facilities.

In the microwave range from 1 to 18 GHz it has, until the present, been customary to interconnect the various circuit components (very high frequency modules) on a soft board (printed circuit board made of a material with a low absorption of electromagnetic waves in the very high frequency range) by means of SMD methods (SMD=Surface Mounted Device). However the SMD components are usually unsuitable for applications at frequencies higher than 18 GHz.

For example, a transceiver module produced by means of this technology, which contains the following components on a 30 mm×30 mm board, is known: a voltage-controlled oscillator made of discrete SMD elements (one transistor and two diodes) and a mixer. In addition, an antenna, a frequency divider and a frequency regulating loop are attached externally to this module.

Modules which can be used for the millimeter wave band are nowadays usually produced on thin layer substrates. The thin layer substrate can simultaneously carry one or more chip elements. The chip elements are fastened to the support substrate and electrically interconnected with it by means of wire bonding or flip-chip methods.

The disadvantage of the heretofore known transceiver modules is that they require a large amount of space and, for this reason, they often do not satisfy the application-orientated requirements (e.g., in radio-linked key applications for automobile remote keyless entry, RKE).

It is the object of the present invention to disclose a novel, highly integrated design of a radar transceiver in a compact module.

This objective is achieved according to this invention by means of an element having the characteristics of claim 1. Advantageous embodiments of this invention are provided by the further claims.

This invention discloses a radar transceiver, containing:
at least one oscillator, which comprises at least one active circuit element, at least one frequency determining oscillator circuit and at least one component that is applicable for purposes of frequency detuning,
at least one mixer, which comprises at least one diode and at least one passive circuit element,
a substrate with at least two dielectric layers located directly on top of each other, in which metallized surfaces are placed on top of, below and between the dielectric layers, such that the lower surface of the substrate has external contacts for connecting it to a system support and the top side of the substrate has contacts for connecting it to the external electrodes of the at least single individual electronic component,
one or more individual electronic components located on the top side of the substrate, which comprise
at least one active or nonlinear circuit component of the mixer and
at least one active or nonlinear circuit component of the voltage-controlled oscillator,
   where the at least single passive circuit element of the mixer and/or the at least single resonant circuit of the voltage-controlled oscillator is integrated in one of the metallized surfaces of the substrate.

The at least single passive circuit element of the mixer and/or the at least single resonant circuit of the voltage-controlled oscillator are preferably at least partly integrated in the internal metallized surfaces of the substrate. Said elements can also be at least partly distributed over several internal metallized surfaces instead of in only one internal metallized surface. In an advantageous variant, the passive circuit element of the mixer and/or the resonant circuit of the oscillator are located entirely in the interior of the substrate.

At least one internal metallized surface is thus structured so that at least one passive circuit element of the radar transceiver circuit is built up on this surface, in addition to shielding metal (ground plane) surfaces or the circuit terminations of a connecting circuit, which may also be located in this plane.

The connection between the metallized surfaces preferably occurs by means of plated pass-through holes. It is also possible to make the connection through capacitive or inductive field coupling of two metal structures located on different metallized surfaces.

Said oscillator is preferably a voltage-controlled oscillator.

The oscillator generates electromagnetic oscillations in the radar transceiver at the given very high frequency—a reference signal, which is directed over the transmission path at an external transmitting antenna or an antenna integrated in the substrate of the radar transceiver and is emitted from there toward a target object as the transmitted signal. The signal reflected by the target object arrives at the mixer via the receiving antenna and the reception path of the radar transceiver and the mixer mixes the transmitted and received signals with each other and supplies a demodulated signal. The demodulated signal is passed to an ASIC (Application Specific Integrated Circuit), which contains a frequency control loop, preferably a phase locked loop (PLL) and outputs a control voltage for purposes of frequency control of the (voltage-controlled) oscillator. The oscillator usually contains at least one nonlinear (or active) circuit element for purposes of frequency detuning, e.g., a varactor diode. The frequency control loop is, e.g., a digital or analog PLL or an analog frequency control strip.

The ASIC is expediently connected externally. It is possible for the ASIC to be attached to the top side of the substrate as an individual component.

These or other individual electronic components that are present have at least two external electrodes located on the bottom surface, which electrodes are electrically connected with the contacts on the top side of the substrate.

An individual electronic component is above all a nonlinear or an active electronic element, in particular a chip element.

A nonlinear or active individual component is understood to be a discrete nonlinear or active circuit element such as a diode or a transistor, or a chip element with or without a housing comprising at least one nonlinear or active component. The nonlinear or active individual component can, in addition, comprise one or more passive circuit elements (selected from among an inductance, a capacitance, a resistance, a circuit termination).

The active individual component that is constructed as a chip element can be a microwave chip, a millimeter wave chip or an IC element (IC=Integrated Circuit). The IC element can in turn be an MMIC element (MMIC=Monolithic Microwave Integrated Circuit).

The active individual components can, for example, be constructed using Si, SiGe, GaAs or InP semiconductor technology.

Aside from one or more nonlinear or active individual components, the radar transceiver module of this invention can also contain one or more passive individual components.

A passive individual component is a discrete element selected from among a capacitor, a coil, a resistor or a chip element which comprises at least a part of the following circuits: an RLC circuit, a filter, a switch, a directional coupler, a bias network, an antenna, an impedance buffer or an adaptive network.

The individual electronic component has at least two external contacts for establishing an electrical connection with the metallic structures embedded in the substrate.

In the very high frequency range relevant to this invention, the at least single individual electronic component is preferably connected mechanically or electrically to the substrate and to the integrated circuit elements by means of the flip chip method, so that its structured side faces the top side of the substrate.

Aside from the at least single (nonlinear, passive or active) individual electronic component, one or more discrete electronic elements (e.g., a coil, a capacitor or a resistor) as well as one or more supporting substrates with passive HF structures such as filters or mixers, in particular supporting substrates structured with thin layer technology, can be located on the top side of the substrate.

Substrates are here understood to be all kinds of planar circuit supports. These include ceramic substrates (thin layer ceramics, thick-film ceramics, LTCC—Low Temperature Cofired Ceramics, HTCC—High Temperature Cofired Ceramics, LTCC and HTCC are multilayer ceramic circuits), polymeric substrates (conventional printed circuit boards, such as FR4, so called soft substrates whose polymer base e.g., consists of PTFE=Teflon or polyolefins and which are typically glass fiber reinforced or filled with ceramic powders), silicon as well as metallic substrates in which metallic printed circuits and a metallic base plate are insulated from each other by means of polymers or ceramic materials. Substrates are here understood to also include so called Molded Interconnection Devices (MID), which consist of thermoplastic polymers on which printed circuits are formed. A substrate in the sense of this invention is preferably of the monolithic design, where, in the case of a ceramic substrate, all dielectric and metal layers are produced in a single process or are sintered together.

The substrate contains integrated circuit elements, above all passive circuit elements of the mixer (in particular a hybrid loop), the oscillator (in particular a resonant circuit) and the structures of one or more low-pass filters. An integrated circuit element is in particular understood to be an inductance, a capacitance or a line, e.g., a transmission line emitter, a connecting line, or a line termination. These can, in a known manner, be present as printed circuits in between, within and on top of the dielectric layers of a substrate having a multilayer structure and they thus constitute integrated circuit elements. Vertical connections between the printed circuits in different layers (plated-through holes) also count as integrated circuit elements, since on the one hand they serve the purpose of vertical signal transmission and on the other hand, in particular in the very high frequency range, they represent both a (parasitic) inductance and a (parasitic) capacitance. Several individual integrated circuit elements together form integrated circuits, in particular passive circuits such as a filter or (at least a part of) a mixer. Integrated circuit elements can furthermore constitute at least a part of at least one active circuit which is electrically connected with the active individual components on the surface of the substrate.

In the case of very high frequencies, particularly in the mmW range, capacitances and inductances are often present as distributed elements constituted by line terminations. The capacitances can, for example, be configured as radial stubs.

The bottom surface of the substrate has external contacts for establishing an electrical connection with, for example, the printed circuit board of a terminal device.

Metallized surfaces are particularly located between the dielectric substrate layers. The top side of the substrate and the bottom surface of the substrate are here also considered to be metallized surfaces.

The top side of the substrate carries conductive structures (metallizations) which are suitable for producing an electrical connection between the metallized surface within the substrate and the at least single individual electronic component on the top side of the substrate.

The total thickness of the dielectric substrate layers is typically between 0.3 and 1.5 mm.

In comparison with known radar transceiver modules, the radar transceiver module of this invention is characterized by a three-dimensional integration of the circuit elements (in particular those of the mixer and the oscillator) within the substrate and it is thus particularly space-saving (small base surface area).

In the following, this invention is described in greater detail based on exemplary embodiments and the associated schematics and therefore with figures that are not true to scale.

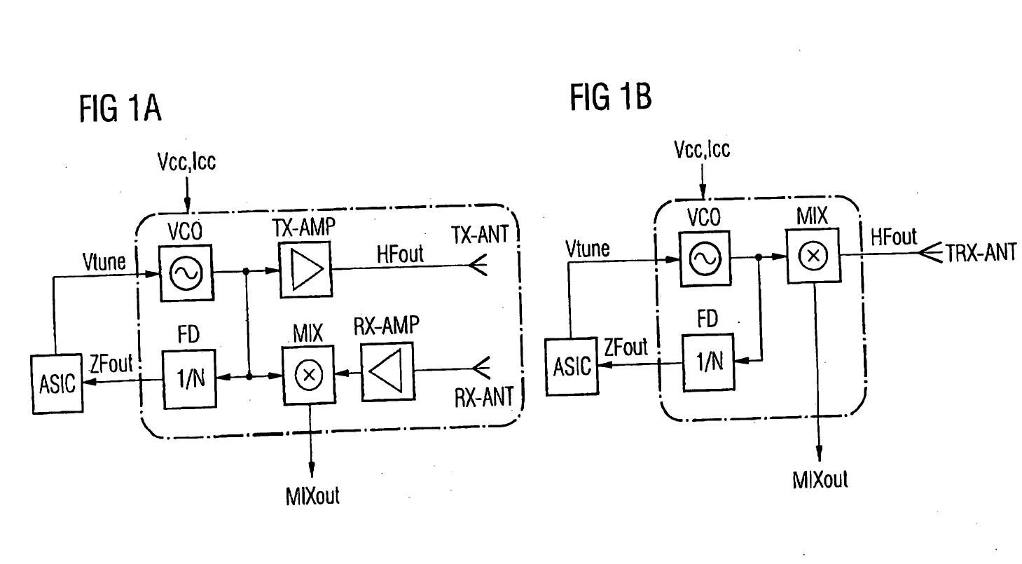

FIGS. 1a and 1b respectively show a block diagram of an exemplary radar transceiver circuit

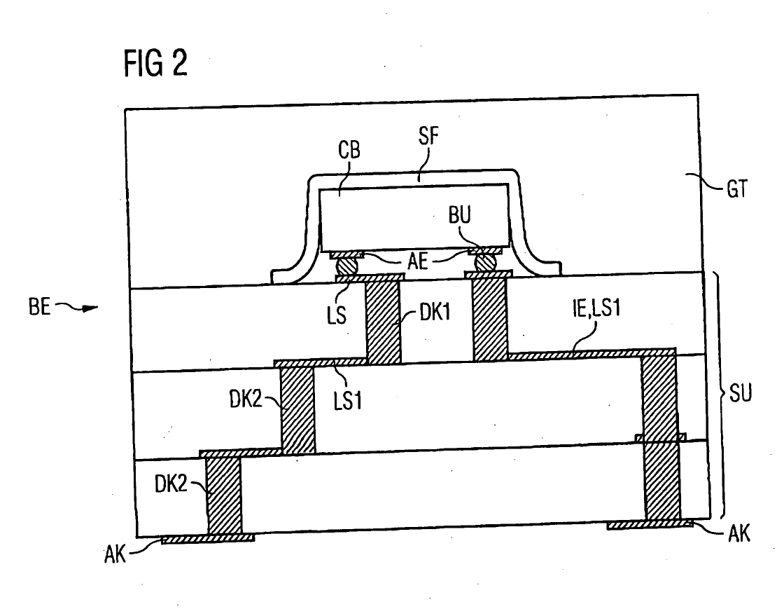

FIG. 2 shows a radar transceiver module of this invention as a schematic cross section

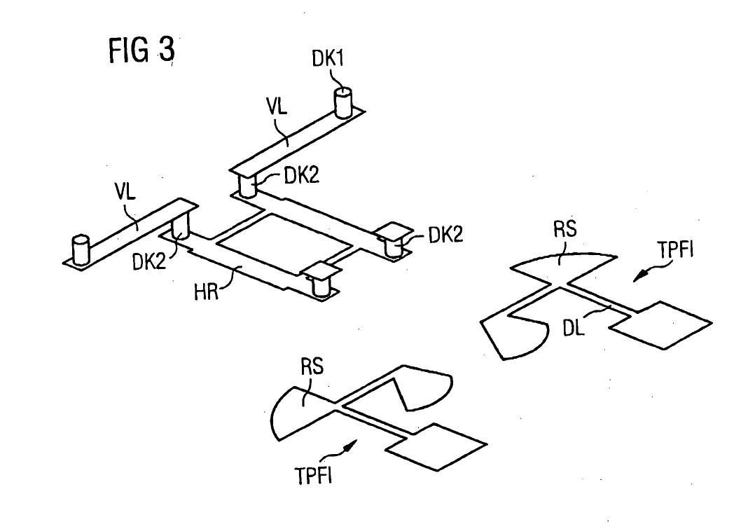

FIG. 3 shows a perspective representation of the three-dimensional integration of the very high frequency circuit elements into the metallized surfaces of the substrate

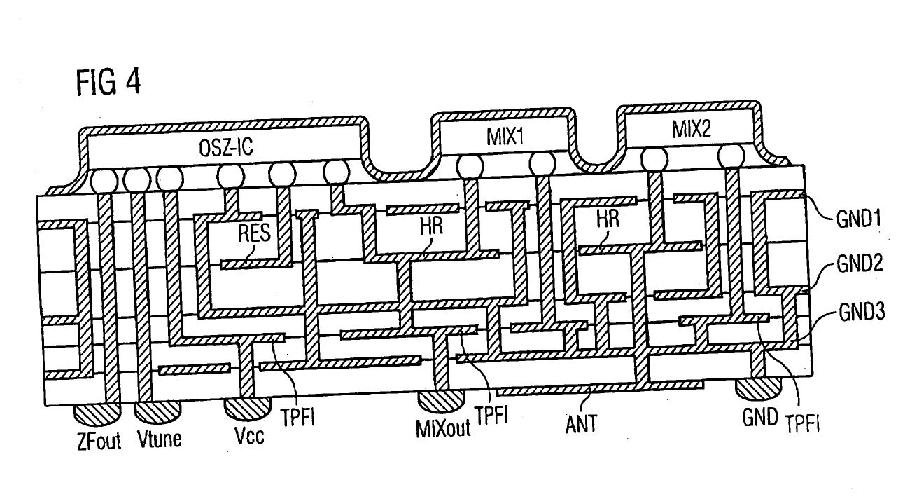

FIG. 4 shows an advantageous embodiment of the radar transceiver module of this invention as a schematic cross section

FIG. 1a represents a block diagram of a radar transceiver circuit.

The radar transceiver module of this invention in FIG. 1a contains a voltage-controlled oscillator VCO, whose frequency is tunable with a control voltage Vtune, a mixer MIX and a customized integrated circuit ASIC with a frequency control loop, e.g., a phase-locked loop PLL (in a further embodiment, the frequency controlled or phase-locked loop can, for example, be integrated in a frequency divider).

The radar transceiver module of this invention shown in FIG. 1a additionally contains a frequency divider FD, which divides the frequency of the output signal of the voltage-controlled oscillator VCO downward and outputs a signal ZFout for controlling the phase-locked loop of the ASIC.

The oscillator, in particular the voltage-controlled oscillator, the frequency divider and the phase-locked loop integrated in the frequency divider or located externally in the ASIC together constitute a frequency control loop.

Alternatively, as in the advantageous embodiment represented in FIG. 1a, the radar transceiver module of this invention can, respectively, contain an amplifier TX-AMP or RX-AMP in the transmission or the reception path. These can be available as individual components that are separated according to their function or they can be located in one or more individual components along with other circuit elements, e.g., the circuit elements of the mixer, the (volt-age-controlled) oscillator or the frequency divider.

That output signal HFout is transmitted by means of the transmitting antenna TX-ANT. The reflected signal is received by the receiving antenna RX-ANT. Both the transmitting antenna and the receiving antenna can be constituted of the metallized surfaces of the substrate (including the bottom surface of the substrate). A further possibility is that the transmitting and/or the receiving antenna are connected externally via very high frequency terminals.

The mixer MIX mixes the received signal with the signal of the oscillator VCO and outputs a demodulated signal MIXout, which carries the desired information (e.g., about the distance or the speed of the target object) and which can be further processed externally to, for example, provide a visual representation.

Said radar transceiver circuits (in particular the active circuit elements) are fed a supply voltage Vcc and/or a current Icc.

The transceiver is simultaneously also applicable for short distance data transmission, e.g., for application as a radio activated key.

Amplitude shift keying ASK or frequency shift keying FSK are applicable e.g., for purposes of simple close distance data communication. Amplitude shift keying is achieved by switching the signal source (the oscillator or the transmission amplifier, if available) on and off at the clock rate of the data bits. Frequency shift keying is achieved by clocking a frequency regulating loop.

In another embodiment of the radar transceiver shown in FIG. 1b, the antenna TRX-ANT simultaneously serves the purpose of radiating the emitted signal receiving the [reflected] signal.

In the radar transceiver module of this invention, all relevant functionalities of a radar transceiver (frequency control of the oscillator, signal amplification, signal emission, signal reception, demodulation) are integrated in a compact module, with the integration of the passive circuit elements taking place in a three-dimensional manner within the metallized surfaces of the substrate; see FIG. 2.

FIG. 2 describes the general properties of the three-dimensional structure of a radar transceiver of this invention by means of a schematic cross section.

FIG. 2 shows the schematic cross section of a radar transceiver of this invention with an individual electronic component CB and a multilayer substrate SU. The individual electronic component CB with outer electrodes AE is, in this case, a chip element, which comprises at least one nonlinear or active circuit element of a mixer and/or of a (voltage-controlled) oscillator (in particular a diode or a transistor). The individual electronic component CB can furthermore contain one or more passive circuit elements (selected from among a capacitor, an inductance or a resistor). The individual electronic component CB is connected electrically by means of bumps BU with various metallized surfaces, which in particular comprise conductive structures LS on the top side of the substrate and further structures LS1 embedded in the multilayer substrate SU. The conductive structures LS and LS1 constitute integrated circuit elements IE. The electrical connection is, for example, made by means of flip chip technology or SMD (SMD=Surface Mounted Device) technology. The substrate SU has conductive structures for purposes of producing said electrical contact with the top side as well as external contacts AK to the bottom surface for purposes of producing an electrical connection with the printed circuit board of a terminal device. The external contacts AK can be configured as Land Grid Arrays (LGA) or it can be additionally provided with solder spheres (μBGA, or Ball Grid Array). Compared with the LGAs, μBGAs have the advantage of higher thermomechanical strength, which is essential for product qualification for automotive applications.

It is additionally possible to use needle-shaped external contacts (leads) and non-galvanic transitions between the structural element and the printed circuit which is to be attached externally, e.g., wave guide transitions or slot couplings (in particular field coupling of the very high frequency signals from the transceiver module to the externally located antenna or to the system support via slot structures located on the bottom surface of the module). The vertical signal transfer within the substrate SU takes place by means of plated-through holes DK1 and DK2.

It is possible that the external electrodes of the individual electronic component are needle-shaped (leads).

The individual components above all comprise nonlinear or active circuit elements of the mixer and the (voltage-controlled) oscillator, which e.g., cannot be integrated in the substrate. It is possible for the circuit elements of the mixer and the oscillator to be (at least partially) configured in a shared individual component or in different individual components.

In an advantageous embodiment of this invention, it is possible for a single individual component (at least partially) to contain the circuit elements of the mixer, the oscillator and of a frequency divider. It is also possible for the circuit elements of the mixer, the oscillator and the frequency divider to be (at least partially) contained in three different individual components. It is furthermore possible for the circuit elements of the mixer and the voltage-controlled oscillator to be (at least partially) located in a shared individual component and for the circuit elements of the frequency divider to be (at least partially) located in a separate individual component. Further possibilities derive from the following combinations: a) the circuit of elements of the mixer and the frequency divider (at least partially) in a shared individual component and the circuit elements of the oscillator (at least partially) in a separate individual component, b) the circuit elements of the oscillator and the frequency divider (at least partially) in a shared individual component and the circuit elements of the mixer (at least partially) in a separate individual component.

In an advantageous embodiment, the radar transceiver module of this invention contains the following single components on the top side of the substrates: an IC, which (at least partially) comprises the (voltage-controlled) oscillator and the frequency divider, as well as one or more (e.g., two or four) discrete diode chips, which accomplish the mixer function; see also FIG. 4.

In place of an integrated circuit, the oscillator can also be (at least partially) composed of discrete transistors, e.g., one or more transistor chips. The mixer can be (at least partially) present as an integrated circuit. The circuits of the mixer, the oscillator and the frequency divider can generally be present as single chip, two chip or three chip solutions. The resonant circuit of the (at least single) oscillator can be partly or entirely implemented on one chip (i.e., in an individual electronic component).

In the advantageous exemplary embodiment of this invention shown in FIG. 2, the at least single individual electronic component CB is covered by a film SF to protect it against humidity and external mechanical effects (cover film).

The film covering represents a film, whose shape is (or becomes) fitted to that of the components which are to be protected (or which are to be covered). The film covering thus extends over the back of the active individual component and seals against all sides of the surface of the substrate so that the active individual component is completely covered and thus protected against external mechanical effects, dust and humidity.

The covering of the individual components with the film is also called laminating. In being laminated the film is permanently deformed. The film covering preferably consists of a polymer which has particularly low water absorption, e.g., polyimide, fluorine-based polymers such as polytetrafluoroethylene (PTFE) or polyolefins such as (cross-linked) polypropylene or polyethylene. The film covering can in addition consist of a metal and it can be particle-filled or fiber-filled. The film covering can furthermore be or become coated with a metal or with ceramic.

It is possible for the film covering to cover all individual components on the top side of the element completely and jointly.

For purposes of shielding against the environment, the film covering can additionally be covered with a metal layer. This layer can, for example be deposited by sputtering, galvanizing, chemical metal separation, vaporization or by a combination of the aforesaid methods. For purposes of mechanical stabilization, the individual components located on the top side of the substrate are, in this exemplary embodiment, covered with a casting resin GT. It is alternatively possible to omit the casting resin. Casting resins are, in this case, understood to be any materials that are applied to the film in the liquid state and are solidified by curing (chemical reaction) or cooling. These include both filled and unfilled polymers, such as masking compounds, Glob Top compounds, thermoplastics or plastic adhesives, as well as metals or ceramic materials, such as ceramic adhesives. Glob Top is a casting compound, which, because of its high viscosity, flows only slightly and therefore encloses the individual components which are to be protected as a droplet-shaped mass.

In an advantageous embodiment of this invention, the metallized film can be covered with a casting resin after it is laminated. In another embodiment, It is possible to apply the metal layer onto the sealing compound rather than onto the cover film.

In an advantageous embodiment of the element of this invention with a ceramic substrate, the film is partially removed at the edges adjoining the substrate—for example, by means of lasers—and is only thereafter coated with metal so that the individual components that are to be covered are completely enclosed by metal or ceramic and are thus hermetically sealed.

It is possible for the radar transceiver module of this invention to receive an (additional) cover for the purpose of mechanical protection of the individual electronic components located on the top side of the substrate.

The bumps BU serve the purpose of producing an electrical connection between the integrated circuit elements IE embedded in the substrate SU and the at least single individual electronic component CB and possibly the further individual components located on the top side of the substrate. The bumps usually consist of solder, for example SnPb, SnAu, SnAg, SnCu, SnPbAg, SnAgCu at different concentrations, or of gold. If the bump is made of solder, the element is connected to the substrate by soldering; if it is made of gold, then the individual components CB and the substrate SU can be interconnected by thermocompression bonding, ultrasonic bonding or thermosonic bonding (sintering or ultrasonic welding methods). For very high frequency applications, the height of the flip chip bumps must be sufficiently low to allow only a small amount of electromagnetic radiation to emerge from the individual very high frequency component and to be absorbed by the laminated film. One possibility for achieving the low height of the flip chip bumps is in particular offered by thermocompression bonding.

In a further embodiment of this invention, the individual electronic components can be SMD components.

Aside from active individual components, it is also possible to attach passive individual components, in particular discrete coils, capacitors, resistors or individual chips with passive circuits (for example filters, mixers, interface circuits) to the top side of the substrate. It is possible to compensate for the detuning of the element by the housing with additional discrete passive compensation structures.

The individual electronic components as well as the integrated circuit components can form at least a part of the following circuits: a high frequency switch, an interface circuit, a high-pass filter, a low-pass filter, a band pass filter, a notch rejection circuit, a power amplifier, a coupler, a resetting coupler, a bias circuit or a mixer.

If the at least single individual electronic component does not contain signal conducting structures on its surface that are to be protected (for example, if all circuit elements and circuits are embedded within the multilayer substrate), it is possible to first cover this individual component with the casting resin and to apply a cover film only after the resin is cured.

The signal lines in the element of this invention can either be completely enclosed within the substrate or at least a part of the signal lines can be located on the top side of the substrate.

It is possible for either at least a part of the signal lines as well as DC connecting lines to be located on the top side or the bottom surface of the substrate, or for all signal lines to be enclosed within the substrate.

The very high frequency connecting lines in the radar transceiver module of this invention can be configured as microstrip lines or as “suspended microstrip” lines (microstrip lines covered with a dielectric), two-wire lines or coplanar lines (three-wire lines) or triplate lines (coplanar lines covered with a dielectric).

The vertical, very high frequency signal pass-throughs can be configured as two or three parallel plated-through holes (with two or three wire lines) or as a kind of coax line. In the latter case, the signal conducting plated-through hole is surrounded by several plated-through holes arranged all around it and connected to ground in the manner of a coaxial connection.

FIG. 3 shows an exemplary integration of the very high frequency circuit elements (in this case a mixer) into the metallized surfaces of the substrate in a perspective view. Two very high frequency connecting lines VL and two low-pass filters TPFI or the hybrid ring HR are located in the upper and/or in the bottom metallized surfaces. Each low-pass filter is constructed of radial stubs RS and thin conductor lines DL. The thin lines then act inductively, and the radial stubs act capacitively. The radius of the radial stubs as well as the length of the thin lines between two radial stubs amount to (approximately) one quarter of the wavelength, so that a short-circuit for very high frequency signals captured at the wide end of the radial stubs occurs at the point of attachment of the radial stubs. The hybrid ring is attached via plated-through holes DK2, e.g., to the mixer diodes located on the top side of substrate or to the mixer IC.

FIG. 4 shows an advantageous embodiment of the radar transceiver of this invention with a (voltage-controlled) oscillator OSZ-IC and two mixer diodes MIX1 and MIX2 as a schematic cross section. The reference symbols in this figure correspond to those in the figures described above. The embedded circuit elements (e.g., the hybrid ring HR, the oscillator resonant circuit RES and the low-pass structures TPFI) are surrounded by ground plane surfaces GND1, GND2 and GND3. The structure ANT is either an antenna structure or alternatively a very high frequency connector to an external antenna.

The substrate contains dielectric layers with differing dielectric constants or different layer thicknesses. In this exemplary embodiment, the dielectric layers, which contain the hybrid ring and the oscillator resonant circuit, are thicker than the layers containing the low-pass structures. The smaller the distance between a metallized surface with the signal carrying structures and a metallized surface with the ground plane and the higher the dielectric constant of the corresponding dielectric layers, the higher is the capacitance (low impedance in the sense of the very high frequency) of the conductor structures located in the first of the aforesaid metallized surfaces.

In this exemplary embodiment, the inside of the substrate is divided into two functional sections—an oscillator section located on the left of the figure and a mixer section located on the right of the figure—to which the external contacts Zfout, Vtune, Vcc and/or MIXout for inputting and outputting the low-frequency signals on the bottom surface correspond.

The mixer section contains a hybrid ring (ratrace or 90° hybrid ring) HR, low-pass structures TPFI, two Schottky diodes MIX1 and MIX2 and the corresponding vertical connections via the plated-through holes. The oscillator section contains an IC, which partially contains the (preferably voltage-controlled) oscillator and a frequency divider (an OSZ-IC), a resonant circuit RES embedded in the substrate, low-pass structures as well as connecting lines and plated-through holes.

The radar transceiver module of this invention represents a component which can be readily processed with conventional standard SMD mounting processes. The radar transceiver module of this invention can in particular be mounted on a system circuit board, e.g., an FR4 printed circuit board or a soft board usually made of laminates.

In the case of particularly complex system topologies, which cannot be achieved in a fully integrated module, it is, according to this invention, possible to achieve the appropriate subfunctions of the radar transceiver in partial modules which are interconnected on a system circuit board. One can, for example, construct the radar transceiver with two separate modules—a partial transmitter module, which contain the oscillator section, and a partial receiver module, which contains the mixers section. In some cases, if an antenna, e.g., a directional antenna, takes up much of the substrate surface, it is expedient to implement such an antenna outside of the substrate or the module which is described here. Suitable system supports for producing the connection between the partial modules and, for example, for implementing the planar antenna are in particular ceramics and laminates based on Teflon or glass fibers.

For the sake of clarity, this invention had been described based only on a few exemplary embodiments, but it is not limited to these. Further possible variations arise from other relative configurations of circuit elements, individual components, the cover film layer, the casting resin and the metal layer, which differ from the embodiments that are represented.

Further possible variation options arise from further relative configurations of the oscillator, the mixer, the frequency divider, the low-pass filter, the amplifier or the antennas in the transmission or reception path, which differ from the represented embodiments.

Further possible variations arise with respect to the number of the (aforementioned) circuits that are used and regarding the method for connecting the individual component to the substrate as well as the substrate to an external printed circuit board.

1. A radar transceiver, comprising:
an oscillator, comprising an active circuit component, a resonant circuits and a circuit component for frequency tuning,
a mixer comprising a diode and a passive circuit component, and
a substrate comprising multiple layers, the multiple layers comprising at least two dielectric layers stacked, the substrate having a metallized top surface, a metallized bottom surface, and metallized internal surfaces located between the dielectric layers,
wherein an electronic component on the metallized top surface of the substrate comprises at least one active or nonlinear circuit component of the mixer and at least one active or nonlinear circuit component of the oscillator, and
wherein the passive circuit component of the mixer or the resonant circuit of the oscillator is integrated in one or more metallized surfaces of the substrate.

2. The radar transceiver of claim 1, wherein the oscillator comprises a voltage-controlled oscillator (VCO).

3. The radar transceiver of claim 1, wherein the circuit component for frequency tuning comprises a nonlinear circuit component.

4. The radar transceiver of claim 1, wherein the circuit component for frequency tuning comprises a varactor diode.

5. The radar transceiver of claim 1, wherein the mixer comprises a hybrid ring that is integrated in the substrate.

6. The radar transceiver of claim 1, further comprising a frequency divider for dividing a frequency of an output signal of the oscillator.

7. The radar transceiver of claim 6, wherein the frequency divider comprises a phase-locked loop.

8. The radar transceiver of claim 1, wherein the metallized bottom surface of the substrate comprises a terminal for connection for connecting to an external antenna.

9. The radar transceiver of claim 1, further comprising a part of at least one antenna that is on the top metallized surface of the substrate or the bottom metallized surface of the substrate.

10. The radar transceiver of claim 1, further comprising a cover film for covering the electronic component at least partly

11. The radar transceiver of claim 10, further comprising a metal layer that at least partly covers the cover film.

12. The radar transceiver of claim 10, further comprising a casting resin that at least partly encases the cover film.

13. The radar transceiver of claim 1, wherein at least one circuit element selected from among an inductance, a capacitance, a line or line termination is integrated in the substrate.

14. The radar transceiver of claim 1, wherein the electronic component comprises a microwave chip, a millimeter wave chip or an integrated circuit element.

15. The radar transceiver according to claim 14, wherein the integrated circuit element comprises a monolithic microwave integrated circuit element.

16. The radar transceiver of claim 1, wherein the electronic component is mechanically and electrically connected to the substrate via flip chip technology or surface mounted device technology.

17. The radar transceiver of claim 1, further comprising one or more electronic components selected from among the following components: a discrete passive circuit element including a coil, a capacitor and a resistor, or which presents a compact circuit block, which contains at least one individual electronic component selected from among a coil, a capacitor or a resistor, including any combination of individual components.

18. The radar transceiver of claim 1, wherein the substrate comprises at least two layers of low temperature cofired ceramic, or high temperature cofired ceramic.

19. The radar transceiver of claim 1, further comprising:
a mixer diode or a chip element that performs, a mixer function; and
a integrated circuit element that comprises at least a part of the oscillator and a frequency divider.

20. The radar transceiver of claim 1, wherein at least a part of the oscillator, a frequency divider, and the mixer is provided in one, two or three integrated circuit elements.

21. The radar transceiver of claim 1, wherein frequency modulation occurs via frequency keying of the oscillator, an amplifier associated with the radar transceiver, or a very high frequency switch associated with the radar transceiver.

22. The radar transceiver of claim 1, wherein amplitude modulation occurs via amplitude keying of the oscillator, an amplifier associated with the radar transceiver, or a very high frequency switch associated with the radar transceiver.

23. The radar transceiver of claim 1, further comprising an integrated circuit element comprising an amplifier that is in a transmission or reception path of the radar transceiver.

24. The radar transceiver of claim 1, wherein the radar transceiver comprises a low temperature cofired ceramic module or as partial modules that are electrically connected with each other, where said partial modules are installed by machine using surface mounted device technology.

25. The radar transceiver of claim 1, wherein the substrate comprises is as a monolithic ceramic object.

26. The radar transceiver of claim 1, wherein the passive circuit component of the mixer, the resonant circuit of the oscillator, or both, are at least partially integrated in at least one internal metallized surface of the substrate.
